(19) United States
(12) Patent Application Publication
(10) Pub. No.: US 2017/0220237 A1
(43) Pub. Date: Aug. 3, 2017

(54) COMPUTER EXECUTION OF APPLICATION WITH SELECTIVE LAUNCH BEHAVIOR

(71) Applicant: Uber Technologies, Inc., San Francisco, CA (US)

(72) Inventors: Bryant Jow, San Francisco, CA (US); Sami Aref, San Jose, CA (US)

(21) Appl. No.: 15/421,035

(22) Filed: Jan. 31, 2017

Related U.S. Application Data
(60) Provisional application No. 62/289,311, filed on Jan. 31, 2016.

(51) Int. Cl. G06F 3/0484; G06T 13/00; G06F 9/44

(52) U.S. Cl. CPC G06F 3/04847; G06F 9/4443; G06T 13/00

(57) ABSTRACT

A computing device retrieves configuration data from a local source that is resident on the computing device, but external to the application. One or more metadata sets are selected based on the configuration data. The computing device displays animation that utilizes the one or more metadata sets before the application is in an open state. Upon the application transitioning into the open state, an initial application panel is displayed in place of the animation. The initial application panel may make at least some functionality of the application available to the user.

### CROSS-REFERENCE TO RELATED APPLICATIONS

This application claims the benefit of Provisional U.S. Patent Application Ser. No. 62/289,311, filed Jan. 31, 2016; the aforementioned priority application being hereby incorporated by reference in its entirety.

### BACKGROUND

With advances in mobile computing platforms, applications are increasingly being implemented to communicate and access significant amounts of data from network services. With increase in data requirements and complexity, the launch behavior of some applications can take several seconds, during which the application appears frozen or stuck.

### BRIEF DESCRIPTION OF DRAWINGS

FIG. 1 illustrates an example application for implementing a selective launch behavior.

FIG. 2 illustrates a sequence diagram for implementing an application as described with an example of FIG. 1.

FIG. 3A-3G illustrates examples of panels for an application that has selective launch behavior.

FIG. 4 illustrates an example method for launching an application to include selected animation content based on parameters determined from the computing device.

FIG. 5 is a block diagram that illustrates a network based computer system for providing an application for execution on client devices as described with examples.

FIG. 6 is a block diagram that illustrates a mobile computing device upon which an application with selective launch behavior can be executed.

### DETAILED DESCRIPTION

Examples provide for an application that executes on a computing device to provide selective launch behavior. Additionally, examples provide for an application that can provide a launch experience that is dynamic and communicative of the state of the application in advance of the application being opened. Among other aspects, examples provide an application launch experience that displays content before the application is opened, where the content is selective as being specific to a category or classification that is determined from local contextual and/or profile information. Still further, the content can also reflect a branding scheme.

In some variations, the content displayed while the application is opening is also dynamic and reflective of a state of the application. The content can visually synchronize to events that occur while the application is opening.

According to some examples, an application can execute on a computing device to implement an application launch sequence in which metadata content is selected and displayed in dynamic form, using selection parameters that are determined from local information on the computing device.

According to one example, an application is initiated on a computing device by an initiation signal. In response, the computing device retrieves configuration data from a local source that is resident on the computing device, but external to the application. One or more metadata sets are selected based on the configuration data. The computing device displays animation that utilizes the one or more metadata sets before the application is in an open state. Upon the application transitioning into the open state, an initial application panel is displayed in place of the animation. The initial application panel may make at least some functionality of the application available to the user. As used herein, an open state of an application can refer to a state in which the application offers user interaction (e.g., via touch gesture input or via an input device) with at least some of application's user interface features and/or functionalities.

As used herein, the “launch behavior” refers to output generated from an application after the application is initiated and before the application is opened or in an open state. An application is opened when the functionality of the application is made available to a user. The application behavior may be selective, in that the output of the application during the launch is based on parameters that are local to the device, and the behavior can change in part when the parameters change.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, components, or components. A programmatic module, component, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines shown with examples described herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

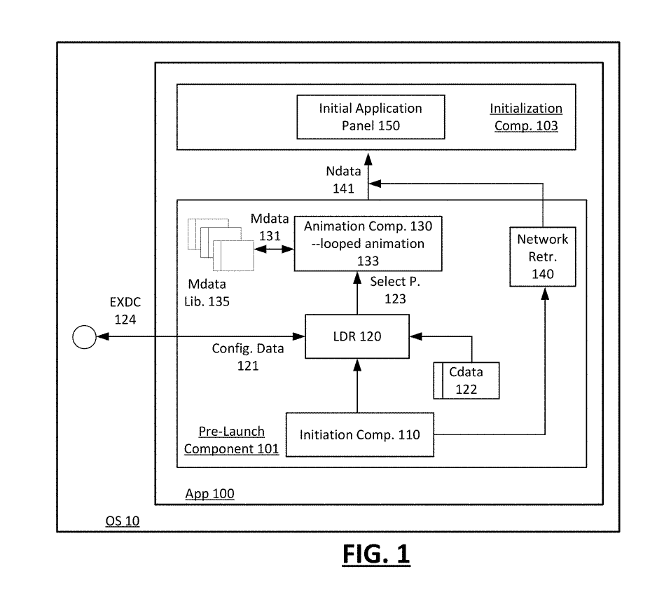

FIG. 1 illustrates an example application for execution on a mobile computing device, according to one or more embodiments. By way of example, the application 100 can be implemented on a mobile computing device, such as a cellular telephony/messaging device, wearable electronic device, tablet computer, notebook computer, or alternative form factor portable computing device. In variations, examples such as provided with application 100 can alternatively be implemented on a desktop computer, laptop or other stationary computer system.

The application 100 can be executed through use of an operating system 10. In some examples, the application 100 can be downloaded from a remote source, and enable network type functionality, such as used to communicate with a network service. Accordingly, the application 100 can be structured to receive and/or transmit network data, and in some examples, the application 100 can include functionality for performing repeated tasks, such as repeatedly sending and receiving communications with a network service and/or maintaining a persistent connection for exchanging communications with the remote network service. In such examples, the application 100 can enable the mobile computing device to operate as part of a program platform for using services provided through a network computer system or other third party.

While an example of FIG. 1 illustrates the application 100 being implemented for specific operating system 10, variants of the application 100 can be implemented on alternative operating systems. In some examples, a server or network computer system can make the application 100 available for download by computing devices that operate different operating systems.

Still further, examples recognize that competing devices can vary in capabilities which may affect some features of examples described. In some implementations, a server or network computer system that provides the application 100 for download can configure the application 100 per capabilities that are specific to the types of computing devices. Still further, a downloaded instance of application 100 can include logic that enables the application 100 to tune or modify features or performance when executing the application 100 based on a determined capability of the computing device. For example, the application 100 can include animation, and a frame rate or resolution of the animation can be adjusted based on determined capabilities of the computing device on which the application 100 is installed.

According to some examples, the application 100 can be implemented through a combination of processes, some of which when initiated or completed, define an application state as described further with examples provided below. In an example of FIG. 1, the application 100 includes a combination of pre-launch processes (shown as pre-launch component 101) and one or more processes for providing application functionality when the application is opened (shown as initialization component 103). Among other technical effects and benefits, the pre-launch component 101 includes functionality for generating animation that is specific to the context or other facet relevant to the computing device on which the application 100 is resident. For example, the pre-launch component 101 can include a visual rendering of metadata sets which are dynamic, intuitively informative of application state or behavior, and specific to contexts such as the geographic region of the computing device. The metadata sets can vary in appearance based on the country or territory where an individual is located when operating the computing device on which the application 100 resides. Alternatively, the metadata sets can vary in appearance based on time of day (or calendar) when the application is opened, information determined or provided with another application on the same device, preference information of the user, or data pushed from a network service.

Still further, in some variations, the metadata sets can implement a dynamic branding scheme where aspects of the content provided for the branding can vary by color, pattern, feature set or other visual facet based on contextual information such as the country or territory where the computing device is present. In some examples, the metadata sets generate a multi-layered branding scheme that is displayed for the user in the duration of time when the application is opening, specifically after the user signals to open the application but before the application is open.

With further reference to an example of FIG. 1, the application 100 may include a launch component 110, local data retrieval (LDR) 120, an animation component 130, and a network retrieval component 140. The launch component 110 can respond to an initiation signal 91, such as to the user providing input to open the application 100 on a computing device. The launch component 110 initiates the LDR 120 and the network retrieval component 140. The LDR 120 performs a local retrieval of a designated local data source 122, 124 in order to determine configuration data 121 that is indicative of a particular context or selection parameter for rendering of animation and/or other content while the application 100 is in the process of being opened. The data source 122 can reflect a cache source, which can store data from a prior use of the application 100. The data source 124 may be external to the application 100 (e.g., phone setting). In some examples, the configuration data 121 is data identifies or is indicative of a country where a user is currently present or was most recently present (e.g., when the application 100 was previously opened on the computing device). As an additional or alternative, the configuration data 121 can include, for example, timing information (e.g., time of day, day a week, day of calendar month or year), a user preference indicator, or other data. The sources of the configuration data 121 can include, for example, the operating system 10 and its repositories of data, data provided with or from a wireless communication module or resource (e.g., SIM card), a user setting (e.g., language preference of the user, type of keyboard the user has selected, preference as to time zone, etc.), a file, or another application (e.g., calendar, in order to obtain an address of the appointment, or GPS application). In some examples, the LDR 120 retrieves the configuration data 121 from a cache. For example, the configuration information can be stored by the application 100 in cache after the application is opened. On a subsequent initiation, the LDR retrieves the configuration data 121 from the cache.

In an example of FIG. 1, the configuration data 121 is communicated as selection parameter 123 to the animation component 130. The animation component 130 uses the selection parameter 123 to select one or more metadata sets 131 from the library 135 of metadata sets. The animation component 130 renders the metadata set 131 as animation content. The metadata sets 131 can, for example, include Scalable Vector Graphic files, which provide XML based image files that can be readily animated. More generally, the animation content can include any computer-generated content which is dynamic. By using selection parameter 123, the animation component 130 generates animation content that is distinctive of what the selection parameter is distinguishing (e.g., country or territory, heritage of user, etc.). The animation component 130 can render animation content for a duration leading up to when the application is opened. A transitional state can terminate the animation content prior to the application being opened, which, as described with some examples below, results in an initial application panel 150 being rendered by initialization component 103. When the initial application panel 150 is rendered, the functionality of the application is made available to the user.

The animation component 130 can also include functionality for altering the rendering of the animation content based on capabilities of the device. For example, the animation component 130 can include logic that detects when the animation content causes the application 100 to crash. In subsequent iterations, the animation component 130 can eliminate metadata sets which may be too problematic for the computing device to execute.

The data for the initial application component 150 can be retrieved from a network source, such as a network service with which the application 100 is programmed to maintain open communications. In one implementation, the data retrieval can be performed by the network retrieval component 140, which can be triggered by the launch component 110 at or near the initial time when the initiation signal is received by the application 100. In variations, the network retrieval component 140 can be initiated before or after the animation content is generated by the animation component 130.

In an example of FIG. 1, the application 100 can progress through several predefined states before opening and rendering the initial application component 150. In examples described, the initial application component 150 signifies a state when the application is open, so that the functionality of the application 100 is available to the user (e.g., the user can provide input). According to some examples, the application 100 exhibits one or more pre-launch states prior to being opened. In at least one pre-launch state (“dynamic pre-launch state”), some examples provide for the application 100 to display dynamic content that is relevant to a particular context of the user, such as the geographic location of the user. Additionally, some examples include a transitory pre-launch state that includes content which visually transitions to the content of the initial application component 150 (in the open state).

In an example of FIG. 1, the animation component 130 generates animation content when the application 100 is in the dynamic prelaunch state. In this state, the animation component 130 generates the animation content while the network retrieval component 140 retrieves and aggregates network data from a remote source. The aggregated network data 141 can be used to trigger the transitory state. When the network data 141 is received for rendering the initial application component 150, the application 100 may transition from the dynamic prelaunch state into a transitory prelaunch state. When in the transitory prelaunch state, the application 100 ceases some operations while the relatively larger task of loading the data set for an initial application interface is performed.

From the transitory prelaunch state, the application 100 transitions into the open state where application content from the network sources is rendered as the initial application component 150. The initial application component 150 can include live or real-time data, such as a map with objects or persons of interest shown in real-time. As described with some examples, when the application 100 transitions to the transitory state, the animation content is altered to visually reflect or indicate an act of completion. Subsequent content can be displayed that is momentary, from the perspective of human perception (e.g., less than 2 seconds, or less than one second, a fraction of a second etc.), before being transitioned to the initial application component 150. For example, a geographic element can be manipulated to reflect the act of completion, which coincides with 100 entering the transitory state, where the data from the network retrieval component 140 is loaded. The geographic element and other accompanying metadata content can be darkened and/or shrunk, reflecting an imminent occurrence, before the initial application component 150 is expanded to occupy and replace the view of the animation content.

According to some examples, the animation component 130 retrieves multiple sets of metadata set 131 from the metadata library 135, with metadata set 131 providing a visual layer of animation content. In one implementation, a first metadata set 131 provides a color scheme or background, a second metadata set 131 provides a texture or pattern, and a third metadata set 131 provides a dynamic background element, in the form of, for example, an atomic element in motion. In this manner, the background and foreground object provide layers from which selection can be made.

In some implementations, the layers can visually indicate information about geography, events, or other context. As an addition or alternative, the layers of content can reflect a branding scheme. For example, a company brand may be reflected or indicated through individual layers or content, or through the combination of layers. The branding can be based on visual characteristics that accompany, for example, other content elements which are designed to be specific to a particular parameter (e.g., country where mobile computing device or user is located). For example, the branding can be reflected by the generic appearance of patterns or texture with dynamic objects (e.g., viewed as atoms), while facets such as color, pattern details, and motion of objects are based on the selection parameter 123.

According to some examples, the animation component 130 generates a looped animation 133 from the metadata sets 131, and specific facets of the looped animation 133 can vary amongst users or devices based on the selection parameter 123, which can reflect user class, contextual category (e.g., country where user is located, native language of user), device class or other considerations. By way of example, the looped animation 133 can include a geometric shape that is manipulated (e.g., spun, reshaped, resized, etc.) with facets of the animation being visually representative of a starting point and an ending point. In one example, the looped animation 133 can be presented by the animation component 130 in the foreground, while content layers which are specific to the metadata set 131 are provided as background. The looped animation 133 can progress from its starting point to its ending point, then repeat until the point where the application 100 is ready to transition into the open state. At that point, the animation content can progress to reflect the looped content in the ending point. For example, the looped content can accelerate to the ending point. In the short duration of time during when the application 100 accelerates or progresses to the ending point, the application 100 may enter into the transitory pre-launch state, where the content and data for the initial application component 150 is loaded. In such an example, the content of the pre-launch state (e.g., metadata content layers), along with any foreground objects that are provided with the looped animation 133, can transition away and be replaced by the initial application component 150.

In mobile computing platforms and other platforms, the application 100 can implement a process to render dynamic network content upon the application being opened (e.g., display map of current location of mobile computing device with live content, etc.).

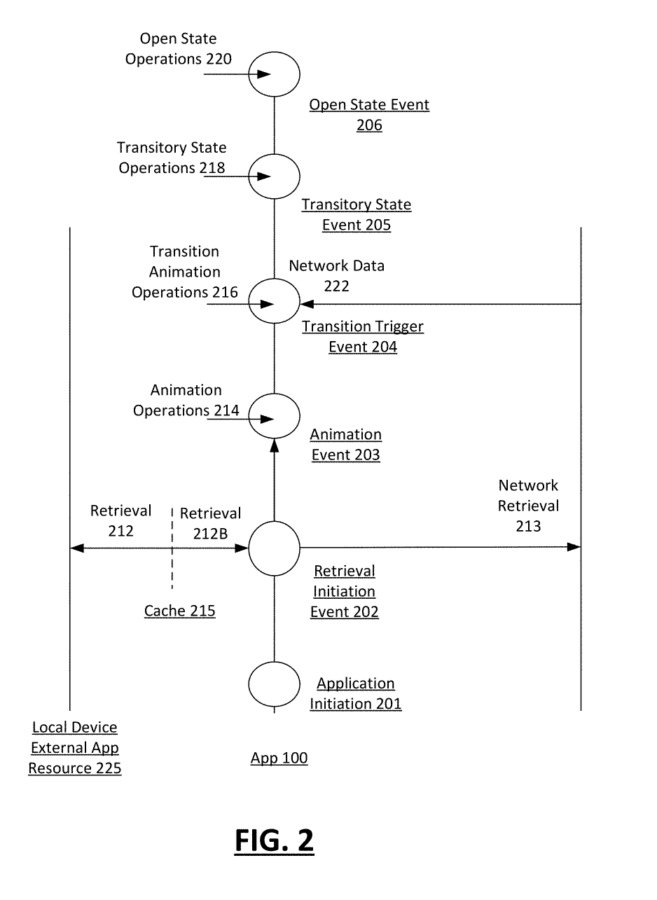

FIG. 2 is a timing sequence for an application that is structured to execute in a manner described with examples of FIG. 1. With reference to FIG. 2, an application initiation event 201 reflects initiation of the application 100. For example, the user may tap an icon on a touch-sensitive display screen of a mobile computing device to launch a desired application.

At retrieval initiation event 202, the application 100 performs operations 212, 212B to retrieve configuration data 121, such as information that indicates a geographic region of the user (e.g., country) or other locality (e.g., city). The operations 212 can retrieve the configuration data 121 from local resources that are external to the application 100 (e.g., phone setting). In variations, operations 212B can perform operations to retrieve the configuration data 121 from a cache 215. The application 100 can also perform network retrievals 213 to request network data and content for the application from a network source, via the network retrieval component 140. The local and network retrievals 212, 213 can be initiated at the same time, performed in sequence, or performed independently of one another.

At animation event 203, the application 100 performs operations 214 to render animation content that is selected based at least in part on the configuration data 121. For example, the selection parameter 123 can be determined from the configuration data 121 and used to select or filter metadata that is then used to generate the animation content. As described with some examples, the operations 214 can include displaying looped content, layers of metadata, and/or transitional graphic content.

At transition trigger event 204, the network content and data 222 may be completely retrieved (or retrieval is about to be completed), and the application 100 performs operations 216 for triggering the animation content to render a transition. In some examples, the looped content generated by the animation component 130 can be accelerated or otherwise moved into a visual state to reflect completion. According to an example, the network content and data 222 can include data that enables the application 100 to display relevant content about the network service to the user.

At transitory state event 205, the application 100 performs operations 218 for entering a transitory or static state where the retrieved network content and data is loaded. At the same time, some examples provide that the animation content is transitioned to reflect another change, such as an imminent event (e.g., animation content is made smaller and panel is darkened).

At open state event 206, the application 100 perform operations 220 for entering the open state. The initial application component 150 may be rendered by initialization component 103 using data and content retrieved by the network retrieval component 140.

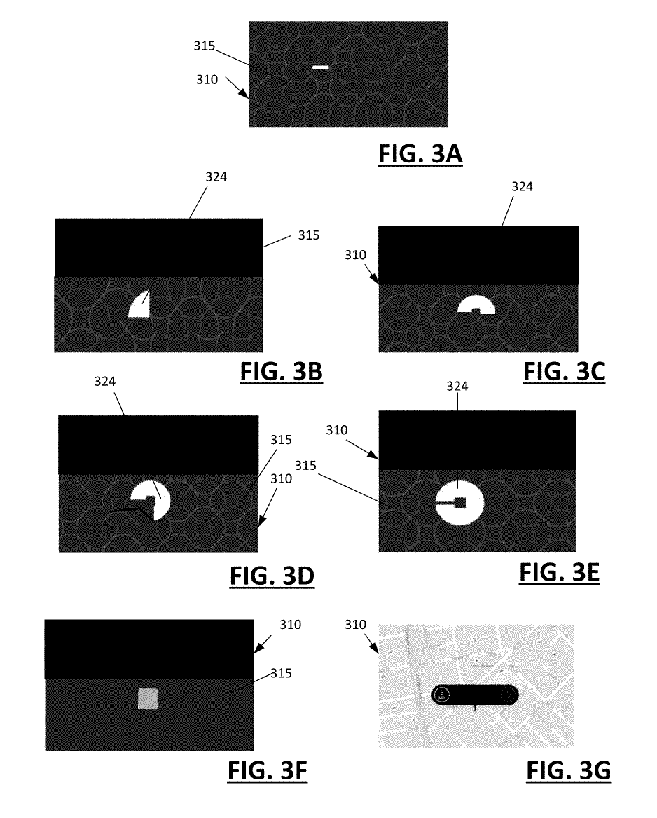

FIG. 3A through FIG. 3G illustrates a sequence in which animation content is generated and transitioned into an application panel or interface, reflecting when the application 100 is opened. In FIG. 3A through FIG. 3E, a panel 310 of the application 100 is used to render animation content 315 while the application 100 is being opened. The animation content can include a patterned, colored and/or dynamic background 322 which is specific to a context (e.g., country where the computing device is present) or profile aspect of the user (e.g., native language of user, country of origin, etc.). The animation content 315 can also include foreground content, shown as an object 324, which visually progresses from an initial or beginning state to a final or ending state. The object 324 can be maneuvered as looped content, having an apparent beginning and end, but restarting from the end to repeat a cycle. With the example shown, the loop of the progressing object 324 includes a starting point shape (FIG. 3A) and an ending point shape 326 (FIG. 3E). In this way, the object 324 can be provided with shaped features that visually communicate a beginning and an end (e.g., a geometric shape that forms, with the ending point reflecting the shape being closed or finished).

While the examples provided reflect the animation and looped behavior in terms of a geometric shape, other objects can also be used to reflect different states of operation of the application 100. In variations to some of the examples described, the looping behavior, use of geometric shapes and various other visual characteristics can vary with design and implementation.

FIG. 3F illustrates an instance of the panel 310 when the application 100 is in the transitory phase. In some examples, the snap shot 318 is dynamic to convey a sense of an imminent occurrence (e.g., fade to black, object shrinking or following a pattern of falling into a drain, etc.).

FIG. 3G illustrates the initial application component 150 rendered on the panel 310 when the application 100 is opened. One benefit of the application 100, in providing pre-launch content as described, is that the user's attention is maintained, while at the same time, the user is informed at a general level of the state of the application 100. Among other benefits, this avoids instances of the user interacting with the panel 310 prior to the application 100 being opened, or the user having a misconception that the application 100 has stalled.

Methodology

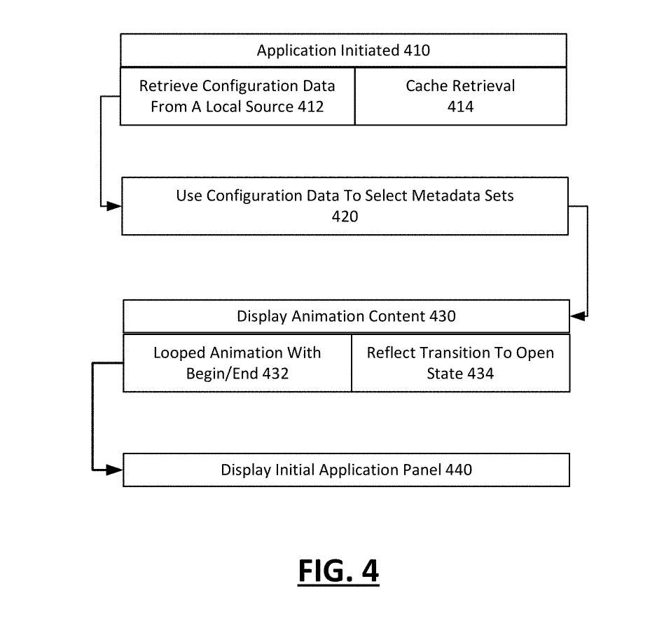

FIG. 4 illustrates an example method for initiating an application on a computing device, according to one or more embodiments. A method such as described with an example of FIG. 4 can be implemented using processes and components such as described with an example of FIG. 1. Accordingly, reference may be made to elements of FIG. 1 for purpose of illustrating a suitable component for performing an operation or task being described.

In one implementation, a computing device is initiated by an initiation signal (410), which may correspond to a user input or other designated triggering event. In response to receiving the initiation signal, the processor of the computing device retrieves configuration data from a local source resident on the computing device (412). In variations, the local data may be stored in cache by the application 100 from a prior retrieval, and the application 100 may perform a cache retrieval to obtain the configuration data 112 (414). For example, when the initiation signal is received, the application 100 can retrieve the configuration data 112 from cache. Subsequently, once the application is opened, the application 100 can determine the local configuration data 112 and then update the cache to reflect the change for the next initiation of the application 100.

In either implementation, the data source may originate or be based on information provided with a local source that is external to the application. For example, the data source can correspond to a file or memory location which stores data provided by the operating system or by another application that executes on the computing device. The source can provide data that is indicative of one or more of (i) a geographic region (e.g., country or territory) or locality (e.g., city) where the computing device is (or likely is); (ii) a native language of the user; (iii) a country of origin of the computing device or user; (iv) preferences or settings of the user; (v) the type of computing device that executes the application; and/or (vi) a class of user (e.g., service provider or customer).

The application 100 uses the configuration data to select one or more metadata sets (420). As described with other examples, the metadata sets can reflect alternative forms of content, including dynamic content (such as provided by animation). In some implementations, the metadata sets represent layers of background content. Additionally, foreground objects, and the manner in which such objects visually represent movement can be determined from the selected metadata set.

In some examples, the application 100 displays animation content that utilizes the one or more metadata sets, and the animation is displayed in advance of the application being opened (430). In some examples, the animation can represent different states of the application during a launch sequence or process (before the application is opened).

In one example, the animation content can be looped to reflect a beginning and an ending moment that occurs as a cycle (432). In this, the animation content can reflect a dynamic prelaunch state, where data from a network source is being retrieved and processed for rendering with the initial application component 150. When the data is retrieved from the network source, the animation content may reflect the transitory pre-launch state (434), at which time the application becomes static while the data from the network source is loaded. The animation generated by the application can reflect both states, as well as the transition from the dynamic prelaunch state to the transitory (or static) pre-launch state. For example, the looping content can be accelerated to visually represent the ending moment of the loop, before transitioning away (e.g., darkens, reduces in size, spins away etc.) to allow for the initial application component 150 to replace the animation content.

Upon the application transitioning into the open state, an initial application panel is displayed in place of the animation (440). The initial application panel making at least some functionality of the application available to the user.

Hardware Diagrams

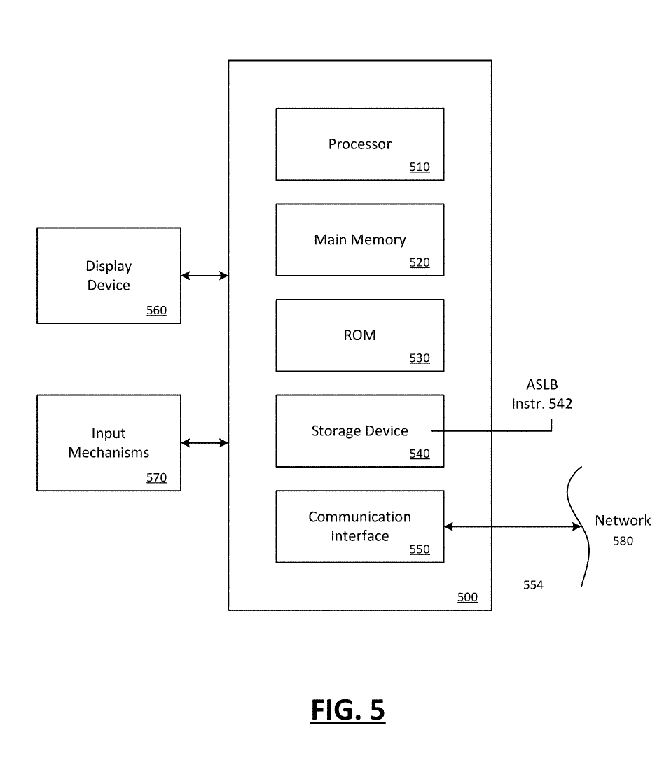

FIG. 5 is a block diagram that illustrates a computer system upon which embodiments described herein may be implemented. For example, in the context of FIG. 1, the operating system 10 may be executed on a computer system such as described by FIG. 5. The operating system 10 may also be executed on a combination of multiple computer systems as described by FIG. 5.

In one implementation, a computer system 500 includes processing resources 510, a main memory 520, a read only memory (ROM) 530, a storage device 540, and a communication interface 550. The computer system 500 includes at least one processor 510 for processing information and the main memory 520, such as a random access memory (RAM) or other dynamic storage device, for storing information and instructions to be executed by the processor 510. The main memory 520 also may be used for storing temporary variables or other intermediate information during execution of instructions to be executed by the processor 510. The computer system 500 may also include the ROM 530 or other static storage device for storing static information and instructions for the processor 510. A storage device 540, such as a magnetic disk or optical disk, is provided for storing information and instructions, including application selective launch behavior (ASLB) instructions 542.

For example, the processor 510 can execute the ASLB instructions 542 to implement logic for structuring an application to have selective launch behavior, such as described in FIGS. 1 through 4.

The communication interface 550 can enable the computer system 500 to communicate with one or more networks 580 (e.g., cellular network) through use of the network link (wireless or wireline). Using the network link, the computer system 500 can communicate with one or more other computing devices and/or one or more other servers or datacenters.

The computer system 500 can also include a display device 560, such as a cathode ray tube (CRT), an LCD monitor, or a television set, for example, for displaying graphics and information to a user. One or more input mechanisms 570, such as a keyboard that includes alphanumeric keys and other keys, can be coupled to the computer system 500 for communicating information and command selections to the processor 510. Other non-limiting, illustrative examples of input mechanisms 570 include a mouse, a trackball, touch-sensitive screen, or cursor direction keys for communicating direction information and command selections to the processor 510 and for controlling cursor movement on the display 560.

Examples described herein are related to the use of the computer system 500 for implementing the techniques described herein. According to one embodiment, those techniques are performed by the computer system 500 in response to the processor 510 executing one or more sequences of one or more instructions contained in the main memory 520. Such instructions may be read into the main memory 520 from another machine-readable medium, such as the storage device 540. Execution of the sequences of instructions contained in the main memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

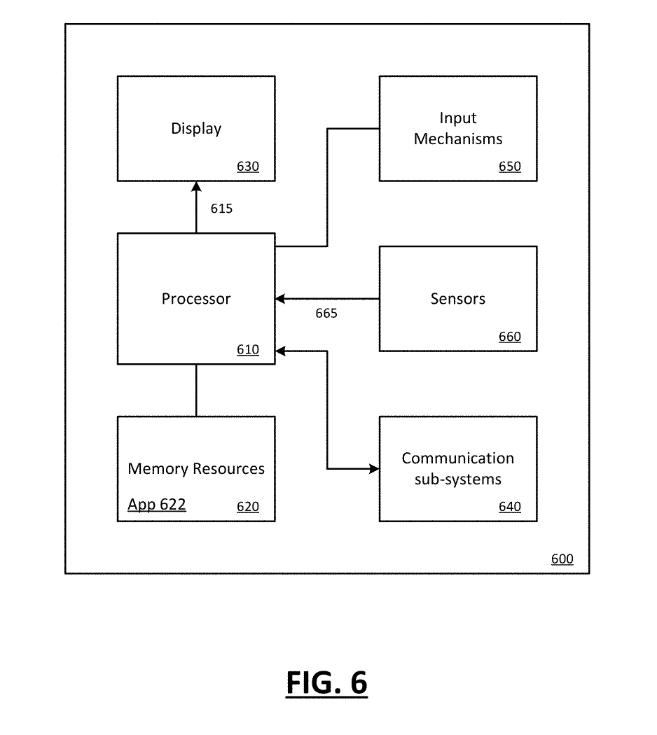

FIG. 6 is a block diagram that illustrates a mobile computing device upon which embodiments described herein may be implemented. In one embodiment, a computing device 600 may correspond to a mobile computing device, such as a cellular device that is capable of telephony, messaging, and data services. In certain examples, the computing device 600 can correspond to a client device or a driver device. Examples of such devices include smartphones, handsets or tablet devices for cellular carriers. The computing device 600 includes a processor 610, memory resources 620, a display device 630 (e.g., such as a touch-sensitive display device), one or more communication sub-systems 640 (including wireless communication sub-systems), input mechanisms 650 (e.g., an input mechanism can include or be part of the touch-sensitive display device), and one or more sensors (e.g., a GPS component, an accelerometer, one or more cameras, etc.) 660. In one example, at least one of the communication sub-systems 640 sends and receives cellular data over data channels and voice channels.

The processor 610 can provide a variety of content to the display 630 by executing instructions and/or applications that are stored in the memory resources 620. In particular, the memory 620 can store application 622, which can launch to exhibit application selection launch behavior, as described herein with respect to FIG. 1 through FIG. 5. For example, the processor 610 is configured with software and/or other logic to perform one or more processes, steps, and other functions described with implementations, such as described by FIGS. 1 through 5, and elsewhere in the application. In particular, the processor 610 can execute instructions and data stored in the memory resources 620 in order to operate, for example, prelaunch and transitory animation functions, as described in FIGS. 1 through 5.

While FIG. 6 is illustrated for a mobile computing device, one or more examples may be implemented on other types of devices, including full-functional computers, such as laptops and desktops (e.g., PC).

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A method for initiating an application on a computing device, the method being implemented by one or more processors and comprising:
responding to an initiation signal by retrieving configuration data from a local source resident on the computing device but external to the application;
selecting one or more metadata sets based on the configuration data;
displaying animation that utilizes the one or more metadata sets before the application is in an open state; and
upon the application transitioning into the open state, displaying an initial application panel in place of the animation, the initial application panel making at least some functionality of the application available to a user of the computing device.

2. The method of claim 1, further comprising:
retrieving data for the initial application panel from a network source while displaying the animation.

3. The method of claim 2, wherein the application is in a dynamic prelaunch state when displaying animation, and transitions into the open state by first entering a transitory prelaunch state.

4. The method of claim 3, wherein in the dynamic prelaunch state, the application loads an initial application panel using data retrieved from the network source.

5. The method of claim 4, further comprising:
displaying a first transitional animation when the application transitions into the transitory prelaunch state.

6. The method of claim 5, wherein displaying animation includes displaying a looped dynamic content having a beginning and an end.

7. The method of claim 6, wherein displaying the first transitional animation includes accelerating progression of the looped dynamic content to display an end of the looped dynamic content before the initial application panel is loaded.

8. The method of claim 3, further comprising displaying a second transitional animation when the application transitions from the transitory prelaunch state into the open state.

9. The method of claim 1, wherein the configuration data is location data which is maintained on the computing device in connection with another function or service.

10. The method of claim 1, wherein the configuration data identifies a country where the computing device is likely to be located.

11. A non-transitory computer-readable medium that stores instructions, which when executed by one or more processors of a computing device, cause the computing device to perform operations that include:
responding to an initiation signal by retrieving configuration data from a local source resident on the computing device but external to an application;
selecting one or more metadata sets based on the configuration data;
displaying animation that utilizes the one or more metadata sets before the application is in an open state; and
upon the application transitioning into the open state, displaying an initial application panel in place of the animation, the initial application panel making at least some functionality of the application available to a user of the computing device.

12. The non-transitory computer-readable medium of claim 11, further comprising:
retrieving data for the initial application panel from a network source while displaying the animation.

13. The non-transitory computer-readable medium of claim 12, wherein the application displays animation is in a dynamic prelaunch state when displaying animation, and transitions into the open state by first entering a transitory prelaunch state.

14. The non-transitory computer-readable medium of claim 13, wherein in the transitory prelaunch state, the application loads an initial application panel using data retrieved from the network source.

15. The non-transitory computer-readable medium of claim 14, further comprising instructions, which when executed by one or more processors of the computing device, cause the computing device to perform operations that include:
displaying a first transitional animation when the application transitions into the transitory prelaunch state.

16. The non-transitory computer-readable medium of claim 15, wherein displaying animation includes displaying a looped dynamic content having a beginning and an end.

17. The non-transitory computer-readable medium of claim 16, wherein displaying the first transitional animation includes accelerating progression of the looped dynamic content to display an end of the looped dynamic content before the initial application panel is loaded.

18. The non-transitory computer-readable medium of claim 13, further comprising instructions, which when executed by one or more processors of the computing device, cause the computing device to perform operations comprising:
displaying a second transitional animation when the application transitions from the transitory prelaunch state into the open state.

19. The non-transitory computer-readable medium of claim 11, wherein the configuration data is location data which is maintained on the computing device in connection with another function or service.

20. A mobile computing device comprising:
a memory to store a set of instructions;
one or more processors that execute the set of instructions to:
respond to an initiation signal by retrieving configuration data from a local source resident on the mobile computing device but external to an application;
select one or more metadata sets based on the configuration data;
display animation that utilizes the one or more metadata sets before the application is in an open state; and
upon the application transitioning into the open state, display an initial application panel in place of the animation, the initial application panel making at least some functionality of the application available to a user of the mobile computing device.
